(19) United States
(12) Patent Application Publication
(10) Pub. No.: US 2026/0312685 A1
(43) Pub. Date: Oct. 8, 2026

(54) ASSEMBLY FOR TRANSMITTING LIGHT AND OPTICAL TRANSCEIVER INCLUDING SAME

(71) Applicant: OPTOMIND INC., Suwon-si Gyeonggi-so (KR)

(72) Inventors: Yung Sung SON, Suwon-si Gyeonggi-do (KR); Yong Geon LEE, Hwaseong-si Gyeonggi-do (KR)

(73) Assignee: OPTOMIND INC., Suwon-si Gyeonggi-do (KR)

(21) Appl. No.: 19/284,797

(22) Filed: Jul. 30, 2025

(30) Foreign Application Priority Data
Apr. 2, 2025 (KR) 10-2025-0042565

(51) Int. Cl. H04B 10/2581; G02B 6/42; H04B 10/50

(52) U.S. Cl. CPC H04B 10/2581; G02B 6/4202; H04B 10/503

(57) ABSTRACT

The present disclosure relates to an optical transmission assembly for optical coupling between a laser module and an optical fiber. The optical transmission assembly includes a first optical assembly comprising a waveguide and a first lens, and a second optical assembly comprising a second lens and an optical fiber guide. Optical signal emitted from the laser module is incident on one end of the waveguide and is emitted from the other end, and the first lens converts radiant light emitted by the other end of the waveguide into collimated light. The collimated light converted by the first lens is incident on the second lens, and the second lens focuses the incident collimated light onto the optical fiber mounted in the optical fiber guide.

### CROSS-REFERENCE TO RELATED APPLICATIONS

This application claims priority to Korean Patent Application No. 10-2025-0042565, filed on Apr. 2, 2025, the entire contents of which are herein incorporated by reference.

### TECHNICAL FIELD

The present disclosure relates to an optical transmission assembly and optical transmitter using the same. More specifically, the present invention relates to an optical transmission assembly for optical coupling between a laser module and an optical fiber, as well as optical transmitter using the same.

### BACKGROUND ART

While optical communication technology has been used primarily for long-distance data transmission, it is also being used for short-distance transmission between servers and for rack-to-rack, board-to-board, and chip-to-chip connections within a single server, taking advantage of its ability to transmit large amounts of data at high speeds. For example, short-range optical connections between servers for high-speed, high-volume data transfer are being used in data centers, cloud computing, high-performance computing (HPC), ultra-high definition (UHD), and three-dimensional visualization technologies.

The light sources used in optical communications are typically laser diodes (LDs) and light-emitting diodes (LEDs). LEDs are mainly used for low-speed, short-distance transmission, and laser diodes are primarily used for high-speed or long-distance transmission. For example, the types of laser diodes are FP Laser (Fabry-Perot Laser), DFB Laser (Distributed Feedback Laser), VCSEL (Vertical-Cavity Surface-Emitting Laser), EML (Electro-absorption Modulated Laser), etc.

Recently, silicon photonics, which modulates light generated from an external laser source using silicon-based photonic integrated circuits (PICs), has been actively adopted as a replacement for laser diodes that generate their own light. Compared to conventional methods, silicon photonics offers the advantage of high-speed data transmission and is advantageous for integration.

A photonic integrated circuit includes an optical modulator and an optical waveguide. An optical signal input from the outside is modulated by the optical modulator according to an electrical signal (data) and transmitted to the outside through the optical waveguide. The optical signal output from the photonic integrated circuit is transmitted through an optical fiber, with single-mode optical fiber typically used for high-speed transmission. Due to the differences in optical mode and effective refractive index between the optical waveguide and the optical fiber, one or more lenses may be used to improve the efficiency of optical coupling.

FIG. 1 is a conceptual diagram of the optical system constituting a conventional optical transmitter including a laser module based on a photonic integrated circuit.

Referring to FIG. 1, a conventional optical transmitter includes a laser module (10), a lens (20), and an optical fiber (30) arranged in a line. The light emitted from the laser module (10) is focused into the optical fiber (30) through the lens (20).

However, in the conventional optical system illustrated in FIG. 1, a precise optical alignment process is required, in which the optical fiber (10) is aligned with the focal length or optical path length at a position separated from the lens (20). For example, when using single-mode optical fiber and setting the offset tolerance corresponding to 1 dB loss, an alignment accuracy of approximately 0.5 μm or less is required. As a result, prior art methods suffer from increased cost and time required for optical alignment.

Furthermore, contamination caused by dust particles or foreign substances may occur on the core of the optical fiber (10) exposed to air, additional optical coupling losses due to Fresnel losses may occur, and the efficiency of the optical coupling may vary depending on the cut quality of the cross-section of the optical fiber (10).

The present disclosure is directed to solving the aforementioned problems, and relates to an optical transmission assembly for optically coupling a laser module based on a photonic integrated circuit with an optical fiber (for transmission), as well as an optical transmitter using the same.

### SUMMARY

### Technical Objective

An embodiment of the present disclosure is intended to provide an optical transmission assembly for optical coupling between a laser module and an optical fiber, as well as optical transmitter using the same.

Also, an embodiment of the present disclosure is intended to provide an optical transmission assembly that enables easy optical alignment, and an optical transmitter using the same.

Furthermore, an embodiment of the present disclosure is intended to provide an optical transmission assembly suitable for automation and high-volume manufacturing, as well as an optical transmitter using the same The objectives of the present disclosure are not limited to those mentioned above, and other objectives and advantages of the present invention, which are not mentioned, can be understood from the following description and will be more clearly understood through the embodiments of the present disclosure. Furthermore, it will be readily apparent that the objectives and advantages of the present disclosure can be realized by the means and combinations thereof as set forth in the claims.

### Technical Solution

An embodiment of the present disclosure is to provide an optical transmission assembly for optical coupling between a laser module and an optical fiber, as well as an optical transmitter including the same.

An optical transmission assembly according to an embodiment of the present disclosure comprises a first optical assembly comprising a waveguide and a first lens, and a second optical assembly comprising a second lens and an optical fiber guide, wherein an optical signal emitted from the laser module is incident on one end of the waveguide and emitted from the other end, and the first lens converts radiant light emitted from the other end of the waveguide into collimated light, and wherein the collimated light converted by the first lens is incident on the second lens, and the second lens focuses the incident collimated light onto the optical fiber mounted in the optical fiber guide.

In an embodiment of the present disclosure, the optical fiber may be a single-mode optical fiber.

In an embodiment of the present disclosure, the waveguide and the first lens may be fixed with spaced apart by the focal length of the first lens in the first optical assembly.

In an embodiment of the present disclosure, the optical fiber guide may be formed such that the optical fiber is mounted at a position spaced apart by the focal length of the second lens.

In an embodiment of the present disclosure, the first optical assembly or the second optical assembly may be formed as a single body.

In an embodiment of the present disclosure, the first optical assembly may be coupled to the laser module via butt-coupling.

In an embodiment of the present disclosure, the laser module may comprise a Photonic Integrated Circuit (PIC).

In an embodiment of the present disclosure, the core of the waveguide may have a greater diameter than the core of an optical waveguide of the Photonic Integrated Circuit.

In an embodiment of the present disclosure, the waveguide may be a multi-mode optical fiber.

In an embodiment of the present disclosure, the waveguide may be a multi-mode waveguide.

In an embodiment of the present disclosure, the waveguide may be a Step Index Polymer Waveguide.

In an embodiment of the present disclosure, the waveguide may be a GI(Graded Index) POF(Polymer Optical Fiber).

In an embodiment of the present disclosure, the waveguide may convert the mode of the optical signal incident from the laser module.

In an embodiment of the present disclosure, the waveguide may convert a single-mode optical signal incident from the laser module into a multi-mode optical signal.

An optical transmitter according to an embodiment of the present disclosure, comprises an optical transmission assembly, a laser module, and an optical fiber, wherein the optical transmission assembly comprising a first optical assembly comprising a waveguide and a first lens, and a second optical assembly comprising a second lens and an optical fiber guide, wherein an optical signal emitted from the laser module is incident on one end of the waveguide and emitted from the other end, and the first lens converts radiant light emitted from the other end of the waveguide into collimated light, and wherein the collimated light converted by the first lens is incident on the second lens, and the second lens focuses the incident collimated light onto the optical fiber mounted in the optical fiber guide.

### Advantageous Effect

The present disclosure relates to an optical transmission assembly and optical transmitter using the same. More specifically, the present disclosure relates to an optical transmission assembly for optically coupling between a laser module and an optical fiber, to an optical transmitter using the same.

According to an embodiment of the present disclosure, it is possible to provide an optical transmission assembly and optical transmitter using the same, which achieves high optical alignment efficiency without requiring expensive equipment or time-consuming processes.

In addition, according to an embodiment of the present disclosure, the optical transmission assembly and optical transmitter using the same can be mass-produced at a low cost.

In addition to the aforementioned, the specific effects of the present disclosure will be described in detail in the following description of embodiments.

### BRIEF DESCRIPTION OF DRAWINGS

FIG. 1 is a conceptual diagram of an optical system constituting a conventional optical transmitter using a laser module that includes a photonic integrated circuit.

FIG. 2 is a conceptual diagram of the optical system constituting an optical transmitter according to an embodiment of the present disclosure.

FIG. 3 is a cross-sectional view of a first optical assembly according to an embodiment of the present disclosure.

FIG. 4 is a cross-sectional view of a second optical assembly according to an embodiment of the present disclosure.

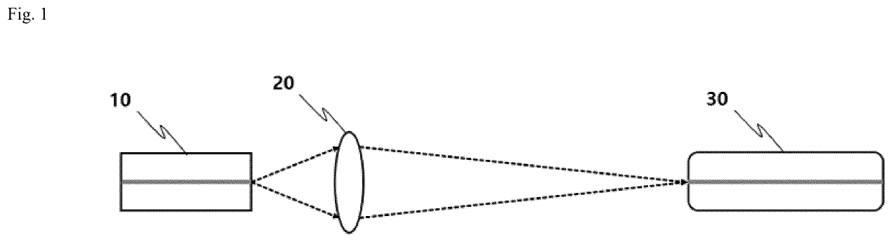

### DETAILED DESCRIPTION OF THE INVENTION

In order to clearly illustrate the technical concept of the present disclosure, embodiments of the present disclosure will be described in detail with reference to the accompanying drawings. In describing the present disclosure, detailed descriptions of well-known functions or components may be omitted when it is determined that such descriptions could unnecessarily obscure the gist of the present disclosure. For components having substantially the same configuration among the drawings, the same reference numerals and symbols are assigned as much as possible, even if they are shown in different figures. For convenience of description, both the device and method may be described together when necessary. Each operation of the present disclosure does not necessarily have to be performed in the order described, but may be carried out in parallel, selectively, or individually.

The terms used in the embodiments of the present disclosure have been chosen to be as generic as possible in current common usage, considering the functions of the present disclosure, but may vary depending on the intention of a person skilled in the art, the precedent or the emergence of new technologies. Also, in specific cases, terms selected arbitrarily by the applicant may be used, and in such cases, the meaning of the term will be clearly described in the corresponding description of the embodiment. Therefore, the terms used in this specification should not be interpreted simply based on the names of the terms, but should be defined based on the meanings of the terms and the overall content of the present disclosure.

Throughout the present disclosure, singular expressions may include plural expressions unless the context clearly indicates otherwise. The terms such as “comprise” or “have” are intended to indicate the existence of features, numbers, steps, operations, components, parts, or combinations thereof, and are not intended to preclude the possibility of the existence or addition of one or more other features, numbers, steps, operations, components, parts, or combinations thereof. That is, when a certain part “comprises” a certain component throughout the present disclosure, it means that, unless there is a specifically opposing description, it does not exclude other components but may further include other components.

Expressions such as “at least one of” modify the entire list of components, not the components in the list individually. For example, “at least one of A, B, and C” and “at least one of A, B, or C” refer to only A, only B, only C, both A and B, both B and C, both A and C, all of A, B, and C, or a combination thereof.

Terms including ordinals such as first and second may be used to describe various components, but the components are not limited by the terms. The terms are only used to distinguish one component from another component. For example, without departing from the scope of the present disclosure, the first component may be referred to as the second component, and similarly, the second component may be referred to as the first component.

In addition, terms such as “ . . . unit” or “ . . . module” described in the present disclosure refer to a unit that processes at least one function or operation, and may be implemented in hardware, software, or a combination of hardware and software.

Throughout the present disclosure, when a part is “connected” to another part, this includes not only being “directly connected” but also “electrically connected” through another element interposed therebetween. Also, when a part “includes” a component, unless there is a specifically opposing description, it means that it may include other components in addition to the specific component and does not exclude other components.

The expression “configured to ~” used throughout the present disclosure may, depending on the situation, be used interchangeably with expressions such as “suitable for ~”, “having the capacity to ~”, “designed to ~”, “adapted to ~”, “made to ~”, or “capable of ~”. The term “configured to ~” does not necessarily mean that it is hardware-wise “specifically designed to ~”. Rather, in some contexts, the expression “a system configured to ~” may mean that the system is “capable of ~” in combination with other devices or components. For example, the phrase “a processor configured (or set) to perform A, B, and C” may refer to a dedicated processor (e.g., an embedded processor) for performing the relevant operations, or a General-Purpose Processor (e.g., a CPU or application processor) capable of performing the operations by executing one or more software programs stored in memory.

The present disclosure relates to an optical transmission assembly and an optical transmitter using the same. More specifically, the present disclosure relates to an optical transmission assembly for optical coupling between a laser module and an optical fiber, as well as an optical transmitter using the same.

Throughout the present disclosure, “optical coupling” refers to coupling by aligning optical elements with each other so that light is effectively transferred from one optical element to another, and is intended to suppress insertion loss or reflection loss in the process and to increase coupling efficiency.

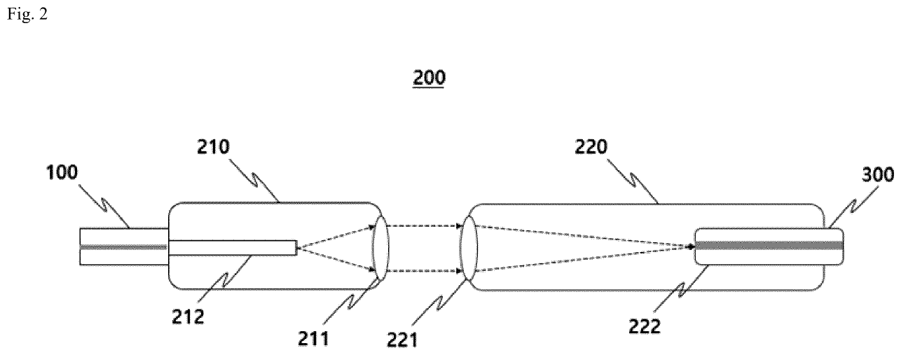

FIG. 2 is a conceptual diagram of the optical system constituting an optical transmitter according to an embodiment of the present disclosure.

Referring to FIG. 2, an optical transmitter according to an embodiment of the present disclosure may comprise a laser module (100) and an optical transmission assembly (200). In an embodiment of the present disclosure, the optical transmission assembly (200) may be coupled to an optical fiber (300) to transmit an optical signal input from the laser module to the optical fiber (300). That is, the optical transmission assembly (200) may form an optical path for transmitting an optical signal from the laser module (100) to the optical fiber (300). However, the components of the optical transmitter are not limited thereto, and may be added to, removed, or modified depending on embodiments.

In an embodiment, the optical fiber (300) may be a single-mode optical fiber. The optical fiber comprises a core and a cladding, and may be fabricated from high-purity glass or synthetic resin. Typically, the refractive index of the core is formed to be higher than that of the cladding, such that light incident on the core is totally internally reflected at the boundary between the core and the cladding, allowing the light to be transmitted over long distances without being lost to the outside. In an embodiment, an outer sheath may be further formed outside the cladding to protect the core and the cladding from external impacts or damage.

In an embodiment, an optical transmission assembly (200) may comprise a first optical assembly (210) and a second optical assembly (220). The first optical assembly (210) may be optically coupled to the laser module (100), the second optical assembly (220) may be optically coupled to the optical fiber (300), and the first optical assembly (210) and the second optical assembly (220) may also be optically coupled to each other. In an embodiment, the first optical assembly (210) and the second optical assembly (220) may be configured to be optically coupled through collimated light. For example, the first optical assembly (210) may be configured to emit collimated light using collimator lens, and the second optical assembly (220) may be configured to focus the incoming collimated light onto the optical fiber (300) using focusing lens.

In an embodiment, the first optical assembly (210) may comprise a waveguide (212) and a first lens (211). Light emitted from the laser module (100) may be incident on one end of the waveguide (212) of the first optical assembly (210). In an embodiment, the waveguide (212) may serve to convert a single-mode laser emitted from the laser module (100) into a multi-mode laser. For example, the waveguide (212) may be a multi-mode fiber (MMF) or a multi-mode waveguide. By converting the optical signal from single-mode to multi-mode via the waveguide (212), the range of tolerance for optical coupling can be increased. For example, if an alignment accuracy of less than 0.5 μm is required for lens and optical fibers when operating in a single-mode, the allowable tolerance can be increased to 5 μm or more in a multi-mode.

In an embodiment, the light that has passed through one end of the waveguide (212) of the first optical assembly (210) is incident on the first lens (211). The first lens (211) may be a collimator lens capable of converting the light emitted from the other end of the waveguide (212) into collimated light. The collimated light converted by the first lens (211) may be incident on the second optical assembly (220).

In an embodiment, the second optical assembly (220) may comprise a second lens (221) and an optical fiber guide (222). Optical signal emitted from the first optical assembly (210) may be incident on the second lens (221), and the collimated light passing through the second lens (221) may be focused onto the core of the optical fiber (300). For example, the second lens (221) may be a focusing lens that can focus collimated light onto the core of the optical fiber (300). In an embodiment, when the first optical assembly (210) and the second optical assembly (220) are arranged in a straight line, an optical path can be formed that passes through the laser module (100), the first lens (211), the second lens (221), and the optical fiber (300) in sequence. In an embodiment, when the first optical assembly (210) and the second optical assembly (220) are optically coupled via collimated light, optical alignment between them can be made easier. Since the optical signal has a wide beam aperture in the collimated state, the lateral tolerance for the alignment of the first lens (211) and the second lens (221) can be increased. That is, even if some of the optical signals are lost due to misalignment of the first lens (221) and the second lens (221), the optical signal can still be effectively transmitted as long as a sufficient portion of the collimated light reaches the second lens (221). For example, if the collimated light has an aperture of 700 μm, the lateral tolerance may be up to 20 μm.

In an embodiment, the laser module (100) may comprise a photonic integrated circuit (PIC) based on silicon photonics. For example, the laser module (100) may output an optical signal through an optical waveguide. The optical waveguide of the laser module (100) may be optically coupled to the waveguide (212) of the first optical assembly (210). For example, the optical waveguide of the laser module (100) may be coupled to the waveguide (212) in a butt coupling arrangement, where the waveguide (212) and the optical waveguide are coupled face-to-face.

In an embodiment, the first optical assembly (210) and the second optical assembly (220) may comprise a configuration for mutual coupling. For example, the first optical assembly (210) and the second optical assembly (220) can be assembled by fitting the second optical assembly (220) into an assembly groove formed in the first optical assembly (210). As another example, each of the first optical assembly (210) and the second optical assembly (220) may comprise one or more recesses that can be assembled with each other. In another embodiment, the first optical assembly (210) and the second optical assembly (220) may be combined to a separate assembly (not shown) to form the optical transmission assembly (200). In another embodiment, the first optical assembly (210) and the second optical assembly (220) may be manufactured as an integral single body from the beginning.

In an embodiment, the first optical assembly (210) and the second optical assembly (220) are preferably formed from a synthetic resin that is rigid yet has some degree of elasticity, but not limited thereto. For example, each of the first optical assembly (210) and the second optical assembly (220) may be formed via an injection molding or three-dimensional printing process using a synthetic resin.

In an embodiment, the laser module (100), the optical transmission assembly (200), and the optical fiber (300) may be used while mounted on a substrate. The substrate may be composed of silicon, silica, or a polymer. Additionally, the substrate may also be formed of resin, glass ceramic, or a metallic material. An optical transmitter, optical receiver, and a plurality of electrical, electronic, and optical components for driving the same may be mounted on the substrate.

Through the optical alignment structure and method described above, the optical transmitter according to embodiments of the present disclosure may enable automatic optical alignment between the optical fiber (300) and the laser module (100) simply by the shape or structure of the coupling portion. Accordingly, by using the optical transmitter according to embodiments of the present disclosure, precise and easy optical alignment can be achieved cost-effectively without time-consuming processes, and the assembly can be easily carried out without expensive equipment, thereby facilitating high-volume manufacturing.

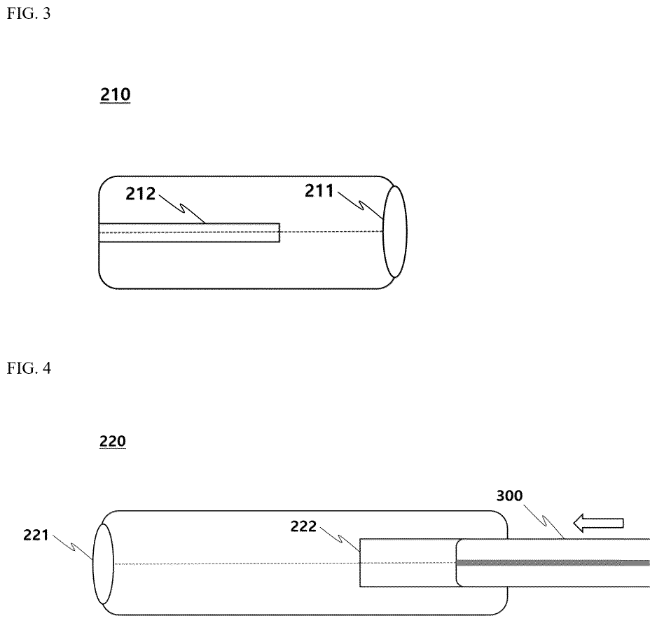

FIG. 3 is a cross-sectional view of a first optical assembly according to an embodiment of the present disclosure.

The first optical assembly (210) according to an embodiment of the present disclosure, may comprise a waveguide (212) and a first lens (211). In an embodiment, the first optical assembly (210) may be configured to protect internal components from the outside.

In an embodiment, the core of the waveguide (212) may be formed with a larger diameter than the core of the optical waveguide of the laser module (100). In an embodiment, when the optical signal emitted from the laser module (100) passes through the waveguide (212), the mode of the optical signal may be converted, thereby facilitating optical alignment. For example, the waveguide (212) may convert a single-mode laser generated by the laser module (100) to a multi-mode signal, which increases the tolerance allowed for optical coupling and thus facilitates optical alignment. For example, the allowable offset tolerance may increase from 0.5 μm to 5 μm or more when converted to a multi-mode signal by the waveguide (212).

In an embodiment, the waveguide (212) may be a multi-mode waveguide or a multi-mode optical fiber. A multi-mode optical fiber is an optical fiber that is designed to allow a plurality of optical signals to be transmitted in different modes simultaneously, and thus has multiple paths through which the optical signals can be transmitted. A multi-mode fiber may have a core with a larger diameter compared to a single-mode optical fiber.

In an embodiment, the waveguide (212) may be a Step Index Polymer Waveguide. A Step Index Polymer Waveguide has a structure in which the differences in refractive indices between the core and the cladding changes rapidly, allowing light to propagate well within the core.

In an embodiment, the waveguide (212) may be a GI POF(Graded Index Polymer Optical Fiber). GI POF has a structure with a gradually varying refractive index and may be used in short lengths. The distribution of refractive indices may vary linearly around the core, may vary sharply in the form of a quadratic curve, or may be designed to have other distributions.

In an embodiment, the first optical assembly (210) may be formed as a single body structure including the waveguide (212) and the first lens (211). That is, the waveguide (212) and the first lens (211) may be integrally formed as part of the body of the first optical assembly (210). For example, one end of the waveguide (212) from which light is emitted and the first lens (211) may be integrally formed to be spaced apart by a predetermined distance for optical coupling. In this case, the waveguide (212) and the first lens (211) are formed already in an optically coupled state, so that no additional optical alignment is required. Since they are formed as a single body, stable optical coupling can be maintained even when external force is applied.

In an embodiment, the waveguide (212) and the first lens (211) of the first optical assembly (210) may be fixed with spaced apart by the focal length of the first lens (211). For example, spacers (not shown), fixing posts (not shown), fixing holes (not shown), and the like may be utilized to maintain a constant distance between the waveguide (212) and the first lens (211) within the first optical assembly (210).

In an embodiment, the first lens (211) may be a collimator lens. For example, the collimating lens may be an aspherical lens and is not necessarily limited thereto. In an embodiment, the first lens (211) may be formed as a molded lens. For example, the first lens (211) may be manufactured by molding, in which a transparent synthetic resin material is placed in a mold and molded under high pressure and temperature. In another embodiment, the first lens (211) may be formed from a metal mirror lens. For example, the first lens (211) may be formed as a reflector made of a metallic material. In this case, the optical path formed by the first optical assembly (210) and the second optical assembly (220) may be twisted at a certain angle.

FIG. 4 is a cross-sectional view of a second optical assembly according to an embodiment of the present disclosure.

The second optical assembly (220) according to an embodiment of the present disclosure, may comprise a second lens (221) and an optical fiber guide (222). In an embodiment, the second optical assembly (220) may be configured to protect internal components from the outside.

In an embodiment, the second optical assembly (220) may be fabricated such that the optical fiber (300) is spaced apart by a predetermined distance for optical coupling between the second lens (221) and the optical fiber (300) when the optical fiber (300) is mounted in the optical fiber guide (222). For example, the optical fiber guide (222) may be formed such that the optical fiber (300) is optically coupled at positions spaced apart by the focal length of the second lens (221). In another embodiment, in the second optical assembly (220), spacers (not shown), fixing posts (not shown), fixing holes (not shown), and the like may be utilized in place of (or in conjunction with) the optical fiber guide (222) to maintain a constant distance between the second lens (221) and the optical fiber (300).

In an embodiment, the second lens (221) may be a focusing lens. The focusing lens may be an aspherical lens, but is not necessarily limited thereto. In an embodiment, the second lens (221) may be formed as a molded lens or a metallic reflective lens, but is not necessarily limited thereto.

In an embodiment, the optical fiber guide (222) may be manufactured in the form of a groove into which an optical fiber can be mounted. In an embodiment, the optical fiber guide (222) may be a hole formed from the inside out, with a gradually increasing cross-sectional area as it goes outward, configured to guide the end of the optical fiber to a predetermined location. By means of this optical fiber guide (222), the optical fiber (300) may be inserted and secured within the second optical assembly (220). In an embodiment, the optical fiber guide (222) may be formed with a predetermined seating length to reliably engage the optical fibers. For example, the optical fiber guide (222) may be formed to a length greater than or equal to the predetermined seating length in the longitudinal direction of the optical fiber (300).

In an embodiment, the second optical assembly (220) may be formed as a single body structure comprising the second lens (221) and the optical fiber guide (222). That is, the second lens (221) and the optical fiber guide (222) may be integrally formed as part of the body of the second optical assembly (220). For example, the second lens (221) and the optical fiber guide (222) may be integrally formed to be spaced apart by a predetermined distance so that optical signals focused by the second lens (221) can be accurately focused onto the optical fiber (300) mounting on the optical fiber guide (222). In this case, the second lens (221) and the optical fiber guide (222) are formed already in an optically coupled state, so that no additional optical alignment is required. Since they are formed as a single body, stable optical coupling can be maintained even when external force is applied.

The above description of the present disclosure is for illustrative purposes, and it will be understood by those of ordinary skill in the art to which the present disclosure pertains that it can be readily modified into other specific forms without departing from the technical spirit or essential features of the present disclosure. Therefore, the embodiments described above should be understood as illustrative in all respects and not as limiting. For example, each component described as being implemented in a singular form may be implemented in a distributed manner, and likewise, components described as being distributed may also be implemented in a combined form.

The scope of the present disclosure is defined not by the above detailed description but by the claims described below, and it should be interpreted that all modifications or altered forms derived from the meaning and scope of the claims and their equivalents are included within the scope of the present disclosure.

### DESCRIPTION OF REFERENCE NUMERALS

100: laser module
200: optical transmission assembly
210: first optical assembly
220: second optical assembly
300: single-mode optical fiber

1. An optical transmission assembly for optical coupling between a laser module and an optical fiber, comprising:
a first optical assembly comprising a waveguide and a first lens; and
a second optical assembly comprising a second lens and an optical fiber guide;
wherein an optical signal emitted from an optical waveguide in the laser module is incident on one end of the waveguide, and wherein the waveguide converts a single-mode optical signal incident from the laser module into a multi-mode optical signal and emits the multi-mode optical signal through the other end of the waveguide, and
wherein the first lens converts radiant light emitted from the other end of the waveguide into collimated light, and wherein the collimated light converted by the first lens is incident on the second lens, and the second lens focuses the incident collimated light onto the optical fiber mounted in the optical fiber guide.

2. The optical transmission assembly of claim 1,
wherein the optical fiber is a single-mode optical fiber.

3. The optical transmission assembly of claim 1,
wherein the waveguide and the first lens are fixed with spaced apart by a focal length of the first lens in the first optical assembly.

4. The optical transmission assembly of claim 1,
wherein the optical fiber guide is formed such that the optical fiber is mounted at a position spaced apart by a focal length of the second lens.

5. The optical transmission assembly of claim 1,
wherein the first optical assembly or the second optical assembly are formed as a single body.

6. The optical transmission assembly of claim 1,
wherein the first optical assembly is coupled to the laser module via butt-coupling.

7. The optical transmission assembly of claim 1,
wherein the laser module comprising a Photonic Integrated Circuit (PIC).

8. The optical transmission assembly of claim 7,
wherein a core of the waveguide has a greater diameter than a core of an optical waveguide of the Photonic Integrated Circuit.

9. The optical transmission assembly of claim 1,
wherein the waveguide is a multi-mode optical fiber.

10. The optical transmission assembly of claim 1,
wherein the waveguide is a multi-mode waveguide.

11. The optical transmission assembly of claim 1,
wherein the waveguide is a Step Index Polymer Waveguide.

12. The optical transmission assembly of claim 1,
wherein the waveguide is a GI (Graded Index) POF (Polymer Optical Fiber).

13. (canceled)

14. (canceled)

15. An optical transmitter comprising:
an optical transmission assembly;
a laser module; and
an optical fiber;
wherein the optical transmission assembly comprising:
a first optical assembly comprising a waveguide and a first lens; and
a second optical assembly comprising a second lens and an optical fiber guide;
wherein an optical signal emitted from an optical waveguide in the laser module is incident on one end of the waveguide, and wherein the waveguide converts a single-mode optical signal incident from the laser module into a multi-mode optical signal and emits the multi-mode optical signal through the other end of the waveguide, and wherein the first lens converts radiant light emitted from the other end of the waveguide into collimated light, and
wherein the collimated light converted by the first lens is incident on the second lens, and the second lens focuses the incident collimated light onto the optical fiber mounted in the optical fiber guide.
